(19) United States
(12) Patent Application Publication
(10) Pub. No.: US 2026/0154373 A1
(43) Pub. Date: Jun. 4, 2026

(54) NON-TRANSITORY COMPUTER-READABLE MEDIUM, CALCULATION METHOD, AND INFORMATION PROCESSING DEVICE

(71) Applicant: Fujitsu Limited, Kawasaki-shi (JP)

(72) Inventor: Yuma ICHIKAWA, Kawasaki (JP)

(73) Assignee: Fujitsu Limited, Kawasaki-shi (JP)

(21) Appl. No.: 19/274,758

(22) Filed: Jul. 21, 2025

(30) Foreign Application Priority Data
Aug. 26, 2024 (JP) 2024-144331

(51) Int. Cl. G06F 17/18

(52) U.S. Cl. CPC G06F 17/18

(57) ABSTRACT

There is provided a non-transitory computer-readable medium storing a calculation program for causing a computer to execute a process. The process includes expanding a discrete variable indicating 1 or 0 to a continuous variable ranging from 0 to 1, and controlling strength of a bias of whether the continuous variable expanded resembles ½, or 0 or 1 during a sampling from a probability distribution of a discrete variable is performed.

### CROSS-REFERENCE TO RELATED APPLICATION

This application is based upon and claims the benefit of priority of Japanese Patent Application No. 2024-144331 filed on Aug. 26, 2024, the entire contents of which are incorporated herein by reference.

### FIELD

A certain aspect of the present embodiments relates to a non-transitory computer-readable medium, a calculation method, and an information processing device.

### BACKGROUND

Technologies for sampling complex probability distributions have been disclosed (see, for example, Japanese Patent Application Publication No. 2024-513576, U.S. Patent Application Publication No. 2009/0287623, and Japanese Patent Application Publication No. 2021-197189).

### SUMMARY

According to an aspect of the present disclosure, there is provided a non-transitory computer-readable medium storing a calculation program for causing a computer to execute a process, the process including: expanding a discrete variable indicating 1 or 0 to a continuous variable ranging from 0 to 1, and controlling strength of a bias of whether the continuous variable expanded resembles ½, or 0 or 1 during a sampling from a probability distribution of a discrete variable is performed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram illustrating a probability distribution p(x);

FIG. 1B is a diagram illustrating a static Monte Carlo method;

FIG. 1C is a diagram illustrating a Markov chain Monte Carlo method;

FIG. 2A is a diagram of a case where transitions are made only to states that are not significantly different from a previous state;

FIG. 2B is a diagram of a case where transitions are made to states that are as different as possible from a previous state;

FIG. 3 is a diagram illustrating local transitions;

FIG. 4 is an example of executing a Metropolis method on a two-dimensional, two-component Gaussian distribution;

FIG. 5A is a functional block diagram of an overall configuration of an information processing device in accordance with a first embodiment;

FIG. 5B is a hardware configuration diagram of an information processing device; and

FIG. 6 is a flowchart of an example of an operation of an information processing device.

### DETAILED DESCRIPTION

If the probability distribution is complex, such as having multiple peaks, it may not be possible to achieve appropriate sampling.

The Markov chain Monte Carlo method (MCMC method) has come to be applied to a wide range of statistical problems, such as large-scale numerical calculations of proteins or Bayesian statistics. For example, the Markov chain Monte Carlo method is applied to many-body problems that appear in physics. This is because many-body problems that appear in physics are generally impossible to calculate analytically, and it is necessary to sample the state of the physical system to investigate its properties. The Markov chain Monte Carlo method is also applied to Bayesian statistics for data analysis. In Bayesian statistics for data analysis, sampling from the posterior distribution is necessary in Bayesian statistics when considering fitting experimental data to an effective model.

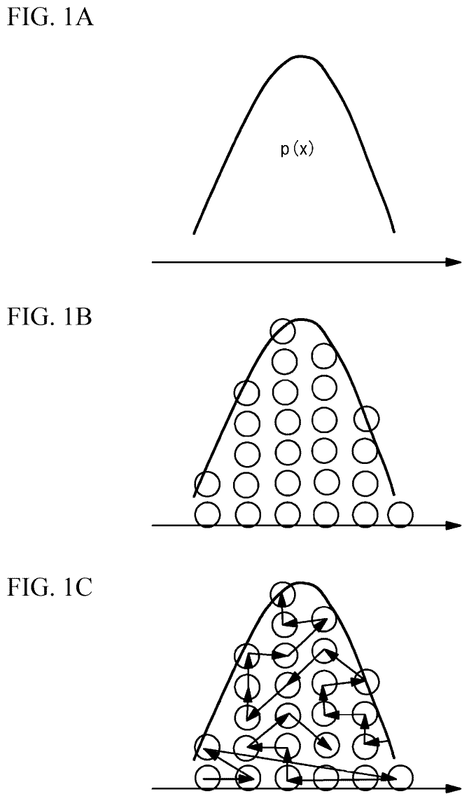

Sampling here means obtaining a specific sample from a probability distribution p(x) that is explicitly given by a formula. FIG. 1A illustrates an example of a probability distribution p(x). Obtaining a sample corresponds to generating random numbers from a given probability distribution.

The Monte Carlo method is a general term for methods of sampling from a probability distribution p(x). In a broad sense, the Monte Carlo method is a general term for a method of performing numerical calculations using random numbers.

The static Monte Carlo method is a general term for a method of performing sampling without using a Markov chain. A Markov chain is a stochastic process in which the current state depends only on the previous state. As illustrated in FIG. 1B, sampling is performed without depending on the previous state in the sampling process. In FIG. 1B, each circle is a sampling point, and they do not have any dependency on each other. With such a static Monte Carlo method, it is difficult to sample a high-dimensional probability distribution.

The Markov chain Monte Carlo method is a general term for a method of performing sampling using a Markov chain. In the Markov chain Monte Carlo method, sampling is performed depending on the previous state in the sampling process, as illustrated in FIG. 1C. In FIG. 1C, the starting point of the arrow represents the previous sampling point, and the end point of the arrow represents the next sampling point.

In the Markov chain Monte Carlo method, it is possible to transition to a state that is as different as possible from the previous state. By transitioning to a state that is different from the previous state, the autocorrelation of the sample sequence is reduced, and the number of valid samples that can be considered independent increases. Furthermore, the Markov chain Monte Carlo method is capable of transitioning to the entire space of random variables in a realistic amount of time.

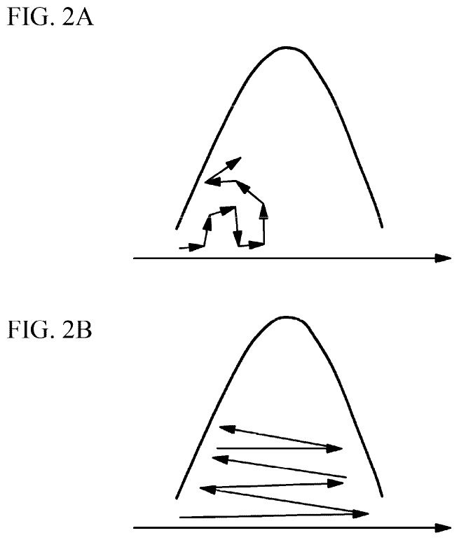

For example, if transitions were only made to states that were not very different from the previous state, the sampling area would be biased, as illustrated in FIG. 2A, which could result in inefficient sampling. In contrast, if transitions were made to a state that was as different as possible from the previous state, the sampling area would not be biased, as illustrated in FIG. 2B, which would improve sampling efficiency.

For a Markov chain to converge to a desired probability distribution, the transition probability K(X′|X) from a state X to a state X′ should satisfy the following two necessary conditions.

### (1) Balance Condition

$$\int p ( x ) K ( {x}^{′} \vert x ) dx = p ( {x}^{′} )$$

### (2) Ergodic Condition

The transition probability between any two states X and X′ is not zero, but can be expressed as the product of a finite number of non-zero transition probabilities.

It is difficult to construct a Markov chain that satisfies the balance condition (1) above. Instead, the transition probability is constructed using the detailed balance condition p(x)K(x′|x)=p(x′)K(x|x′), which is a stronger condition.

Next, we will explain the Metropolis method, which is a specific example of a Markov chain Monte Carlo method that satisfies the detailed balance condition above. First, generate x′ according to a certain proposal distribution q(x′|x). Next, x′ is selected as the next state with the selection probability A(x′, x) in the following equation (1).

$$\begin{matrix}[ Equation 1 ] & \\ A ( {x}^{′} , x ) = min ( 1 , \frac{p ( {x}^{′} ) q ( x \vert {x}^{′} )}{p ( x ) q ( {x}^{′} \vert x )} ) & ( 1 )\end{matrix}$$

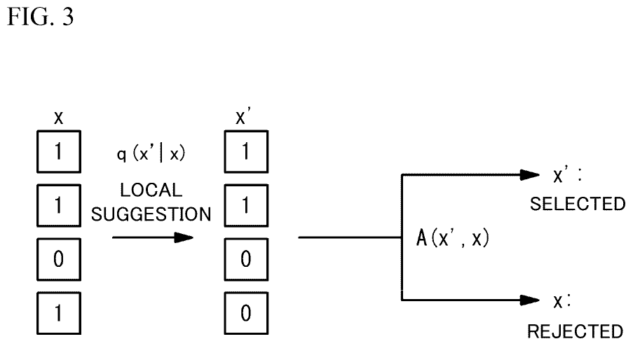

Typically, local transitions are used. For example, a local proposal distribution is used for the proposal distribution q(x′|x). In the case of two values, the dimension of x is selected randomly and the selected value of x is inverted. For example, as illustrated in FIG. 3, the fourth “1” from the top of x is inverted to “0” in x′. In this case, if A(x′, x) becomes small, x′ is selected and x is rejected.

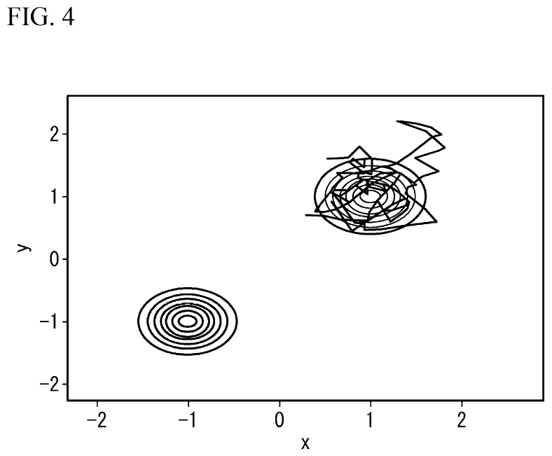

The problems with local transitions are as follows. First, if a large transition is made from the previous state, most states will not be selected. For example, if all the variables of x in FIG. 3 are inverted, none will be selected. Also, in the case of a discrete probability distribution, it is difficult to use gradient information. Furthermore, for certain problems such as multi-modal distributions, the probability of transition to a certain state may become small, and the transition may not actually be made, leading to erroneous results. For example, FIG. 4 illustrates an example of the Metropolis method applied to a two-dimensional two-component Gaussian distribution. The broken line indicates the first 150 transitions. In the example of FIG. 4, sampling is performed around one peak (the peak in the upper right), but not around the other peak (the peak in the lower left).

Therefore, in the following embodiment, an example in which appropriate sampling can be performed will be described.

### First Embodiment

First, the principle of this embodiment will be described. In the first embodiment, a continuously relaxed extended ensemble system is defined, and an efficient Markov chain Monte Carlo method is realized by exchange within the ensemble and gradient-based local transition.

First, a probability distribution defined in a discrete state space x∈{0,1}^{N} is transformed using a real random variable w∈R^{N} as p(x)→p(σ(w))≡p(w). Here, x is a discrete variable vector represented by 0 and 1, and has N elements. “σ” represents an element-wise sigmoid operation from R^{N}→R^{N}, and takes continuous values from 0 to 1.

As an example, the transformation of the following equation (2) for a system with QUBO-format energy can be given. QUBO stands for Quadratic Unconstrained Binary Optimization, which is a format that allows binary optimization without quadratic constraints.

$$\begin{matrix}[ Equation 2 ] & \\ H ( x ) = \frac{1}{2} {x}^{T} Q x \to H ( w ) = \frac{1}{2} {σ ( w )}^{T} Q σ ( w ) & ( 2 )\end{matrix}$$

Next, a term is introduced into the probability distribution p(w). The term represents the strength of the bias of whether the continuous variable extended from the discrete variable is similar to ½ or similar to 0 or 1. For example, the probability distribution of the following equation (3) that takes continuous relaxation annealing into account is defined. In the following equation (3), by setting γ to −∞, the unimodal probability distribution is concentrated at σ(w)=1N/2. By setting γ to +∞, the support is concentrated at the end point of σ(w)∈{0,1}^{N}. Therefore, γ represents the strength of the bias of whether the continuous variable extended from the discrete variable is similar to ½ or similar to 0 or 1. While controlling this γ during the sampling process, sampling of local transitions is repeated.

$$\begin{matrix}[ Equation 3 ] & \\ p ( w ; γ ) = p ( w ) \times {e}^{γ {\sum }_{i = 1}^{N} ( 1 - {( 2 σ ( {w}_{i} ) - 1 )}^{2} )} & ( 3 )\end{matrix}$$

Next, the distribution of the following equation (4) is defined. By defining the distribution of the following equation (4), it is possible to define γ from small to large. By executing gradient-based Markov chain Monte Carlo (Langevin, Hamiltonian MCMC) for the distribution of the following equation (4) and exchanging a randomly selected i with j at an appropriate timing, it is possible to transition the state space quickly. Note that in gradient-based Markov chain Monte Carlo, the state transition is determined based on the probability based on the rate of change of the gradient of the probability distribution.

$$\begin{matrix}[ Equation 4 ] & \\ Path γ = {\{ {γ}_{i} \vert ∀ i < j , {γ}_{i} < {γ}_{j} \}}_{i = 1}^{M} & ( 4 )\end{matrix}$$

The method of exchanging i and j is not particularly limited, but it may be designed to satisfy the detailed balance condition at the time of exchange. For example, a method of exchanging wᵢ and wⱼ with the probability of the following equation (5) can be used.

$$\begin{matrix}[ Equation 5 ] & \\ ℙ [ Swap ( {w}_{i} , {w}_{i + 1} ) ] = min ( 1 , \frac{p ( {w}_{i + 1} ; {γ}_{i} ) p ( {w}_{i} ; {γ}_{i + 1} )}{p ( {w}_{i} ; {γ}_{i} ) p ( {w}_{i + 1} ; {γ}_{i + 1} )} ) & ( 5 )\end{matrix}$$

As described above, in this embodiment, when sampling from the discrete probability distribution of a discrete variable, the discrete variable indicating 1 or 0 is expanded to a continuous variable ranging from 0 to 1, and the strength of the bias of whether the expanded continuous variable resembles ½, or 0 or 1 during the sampling process is controlled. By controlling the strength of the bias in this way, gradient-based local transition becomes possible, and appropriate sampling becomes possible. If appropriate sampling can be performed, the computational resources of the computer can be reduced, and the computer can be improved. In addition, by exchanging γᵢ and γⱼ during the sampling process, the state space can be transitioned at high speed.

Next, a method of application to mathematical optimization will be explained. Mathematical optimization is an optimization problem formulated as in the following equation (6). In the following equation (6), x is a vector represented by 0 and 1, and has N elements.

$$\begin{matrix}[ Equation 6 ] & \\ {min}_{x ∈ {\{ 0 , 1 \}}^{N}} E ( x ) & ( 6 )\end{matrix}$$

For this function, for example, the exponential distribution of the following equation (7) is defined. In the following formula (7), x in p(x;β) represents a variable and β in p(x;β) represents a constant. This exponential distribution converges to a uniform distribution on optimization in the β→∞ limit.

$$\begin{matrix}[ Equation 7 ] & \\ p ( x ; β ) = \frac{1}{Z ( β )} {e}^{- β E ( x )} & ( 7 )\end{matrix}$$

The probability distribution where β is sufficiently large is sampled by the gradient-based Markov chain Monte Carlo method using continuous relaxation in this embodiment. The sampled x becomes a sample sequence near the minimum value of E(x). In this way, this embodiment can be applied to mathematical optimization.

Next, a method of application to an application will be explained. ChatOpt is an expert-free chat application that uses cooperation between the ability to formulate problems from prompts using a large-scale language model and an external solver. The problem of ChatOpt is that the formulation performed by the large-scale language model often results in a nonlinear cost function. If the cost function becomes nonlinear, there is a risk that it will become difficult to use existing optimization solvers (linear programming such as Gurobi, quadratic forms such as Digital Annealer, or the like). In contrast, an extended ensemble using continuous relaxation annealing as in this embodiment can handle any form, making it easy to connect to a large-scale language model. For example, the cost function obtained by the formulation performed by the large-scale language model is regarded as a probability distribution, and the probability distribution is sampled by the gradient-based Markov chain Monte Carlo method using the continuous relaxation of this embodiment. Even if the probability distribution is nonlinear, the probability distribution can be formulated by sampling the probability distribution by the gradient-based Markov chain Monte Carlo method using the continuous relaxation of this embodiment. This makes it possible to provide the probability distribution to an external solver. Note that the large-scale language model is, for example, a trained language model composed of a neural network. Also, the large-scale language model is, for example, a language model that learns using a large amount of calculation, data, and parameters, and executes the learned process using natural language as input and returns a response.

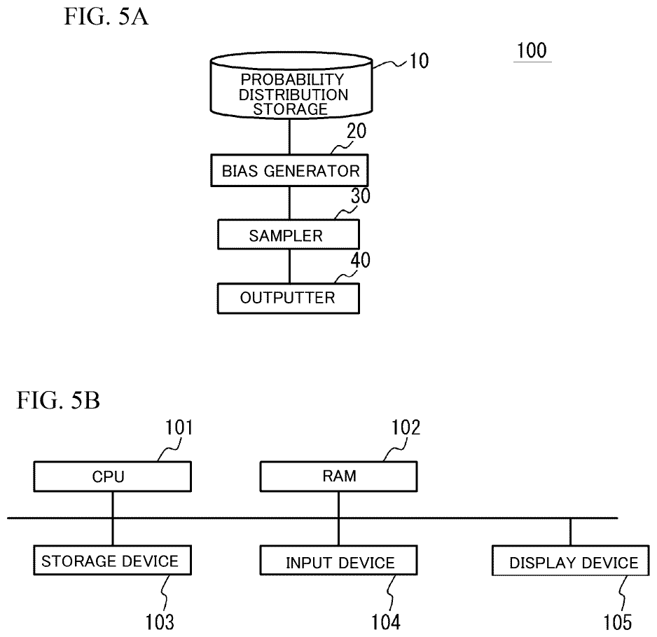

Next, a device configuration for realizing the above solution principle will be described. FIG. 5A is a functional block diagram of the overall configuration of an information processing device 100 according to the first embodiment. The information processing device 100 is a server for sampling or the like. As illustrated in FIG. 5A, the information processing device 100 functions as a probability distribution storage 10, a bias generator 20, a sampler 30, an outputter 40 and so on.

For example, when sampling from the probability distribution of a discrete variable, the sampler 30 expands the discrete variable indicating 1 or 0 to a continuous variable ranging from 0 to 1, and during the sampling process, controls the strength of bias of whether the expanded continuous variable resembles ½, or 0 or 1.

Furthermore, when the probability distribution expanded to a continuous variable is p(w), the strength of bias is γ, and σ is a sigmoid operation, the sampler 30 performs sampling by controlling γ using the following equation.

$$\begin{matrix}[ Equation 8 ] & \\ p ( x ; γ ) = p ( w ) \times {e}^{γ {\sum }_{i = 1}^{N} ( 1 - {( 2 σ ( {w}_{i} ) - 1 )}^{2} )} & \end{matrix}$$

The sampler 30 also defines γ from small to large in the following equation, and exchanges i and j during sampling.

$$\begin{matrix}[ Equation 9 ] & \\ Path γ = {\{ {γ}_{i} \vert ∀ i < j , {γ}_{i} < {γ}_{j} \}}_{i = 1}^{M} & \end{matrix}$$

The sampler 30 also uses a cost function obtained by formulation performed by a large-scale language model as a probability distribution of discrete variables, and provides the cost function obtained by sampling to an external solver.

FIG. 5B is a hardware configuration diagram of the information processing device 100. As illustrated in FIG. 5B, the information processing device 100 includes a CPU 101, a RAM 102, a storage device 103, an input device 104, a display device 105, and the like.

The CPU 101 is a central processing unit. The CPU 101 includes one or more cores. The RAM (Random Access Memory) 102 is a volatile memory that temporarily stores the program executed by the CPU 101 and the data processed by the CPU 101. The storage device 103 is a non-volatile storage device. For example, a ROM (Read Only Memory), a solid state drive (SSD) such as a flash memory, or a hard disk driven by a hard disk drive can be used as the storage device 103. The storage device 103 stores a calculation program. The input device 104 is a device for a user to input necessary information, such as a keyboard or a mouse. The display device 105 is a display device that displays the sampling results output by the outputter 40 on a screen. Each part of the information processing device 100 is realized by the CPU 101 executing the calculation program. Note that each part of the information processing device 100 may be hardware such as a dedicated circuit.

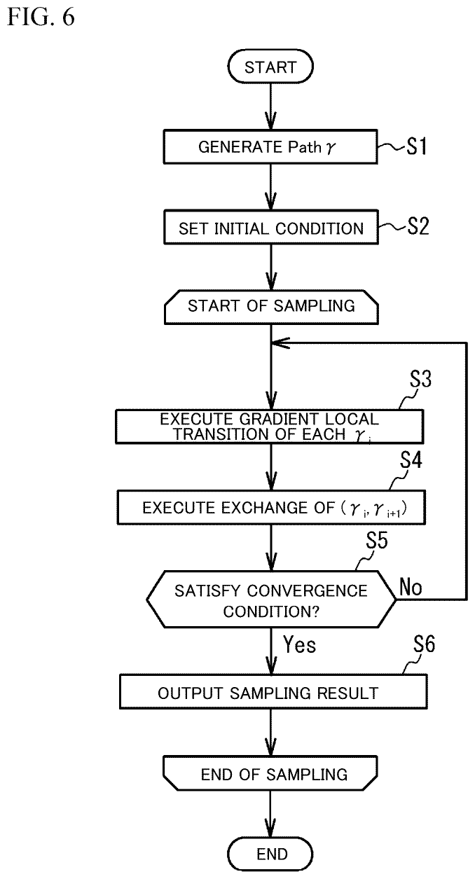

FIG. 6 is a flowchart of an example of the operation of the information processing device 100. As illustrated in FIG. 6, the bias generator 20 generates Path γ of the above equation (4) for the probability distribution stored in the probability distribution storage 10 (step S1).

Then, the sampler 30 sets the initial state of the Markov chain Monte Carlo method (step S2). For example, the sampler 30 sets each parameter of the Markov chain Monte Carlo method to a predetermined initial value.

Then, the sampler 30 executes the gradient local transition of each γi M (≥2) times using the probability distribution of the above equation (3) (step S3).

Then, the sampler 30 executes the exchange of (γᵢ, γᵢ₊₁) (step S4).

Then, the sampler 30 judges whether or not the stopping condition is satisfied (step S5). For example, the sampler 30 judges the degree of convergence of the statistics by detecting whether or not the amount of change of the statistics such as the mean, median, variance, and standard deviation of each sampled sampling point becomes equal to or less than a threshold value.

If the judgment in step S5 is “No”, the process is executed again from step S3. If the judgement in step S5 is “Yes”, the outputter 40 outputs the sampling result (step S6). For example, the display device 105 displays the sampling result output by the outputter 40. Then, the execution of the flowchart ends.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium storing a calculation program for causing a computer to execute a process, the process comprising:
expanding a discrete variable indicating 1 or 0 to a continuous variable ranging from 0 to 1, and controlling strength of a bias of whether the continuous variable expanded resembles ½, or 0 or 1 during a sampling from a probability distribution of a discrete variable is performed.

2. The non-transitory computer-readable medium according to claim 1,
wherein the sampling is performed by controlling γ using a following equation:
$$p ( w ; γ ) = p ( w ) \times {e}^{γ {\sum }_{i = 1}^{N} ( 1 - {( 2 σ ( {w}_{i} ) - 1 )}^{2} )}$$
when the probability distribution expanded to the continuous variable is p(w), the strength of the bias is γ, and σ is a sigmoid operation,

3. The non-transitory computer-readable medium according to claim 2,
wherein the γ is defined from small to large in a following equation:
$$Path γ = {\{ {γ}_{i} \vert ∀ i < j , {γ}_{i} < {γ}_{j} \}}_{i = 1}^{M}$$
and i and j are exchanged during the sampling.

4. The non-transitory computer-readable medium according to claim 1,
wherein a cost function obtained by formulation performed by a large-scale language model is used as the probability distribution of the discrete variables, and
wherein the process comprises providing the cost function obtained by the sampling to an external solver.

5. A calculation method implemented by a computer, the method comprising:
expanding a discrete variable indicating 1 or 0 to a continuous variable ranging from 0 to 1, and controlling strength of a bias of whether the continuous variable expanded resembles ½, or 0 or 1 during a sampling from a probability distribution of a discrete variable is performed.

6. The method according to claim 5,
wherein the sampling is performed by controlling γ using a following equation:
$$p ( w ; γ ) = p ( w ) \times {e}^{γ {\sum }_{i = 1}^{N} ( 1 - {( 2 σ ( {w}_{i} ) - 1 )}^{2} )}$$
when the probability distribution expanded to the continuous variable is p(w), the strength of the bias is γ, and σ is a sigmoid operation,

7. The method according to claim 6,
wherein the γ is defined from small to large in a following equation:
$$Path γ = {\{ {γ}_{i} \vert ∀ i < j , {γ}_{i} < {γ}_{j} \}}_{i = 1}^{M}$$
and i and j are exchanged during the sampling.

8. The method according to claim 5,
wherein a cost function obtained by formulation performed by a large-scale language model is used as the probability distribution of the discrete variables, and
wherein the process comprises providing the cost function obtained by the sampling to an external solver.

9. An information processing device comprising:
a memory; and
a processor coupled to the memory and the processor configured to execute a process, the process comprising:
expanding a discrete variable indicating 1 or 0 to a continuous variable ranging from 0 to 1, and controlling strength of a bias of whether the continuous variable expanded resembles ½, or 0 or 1 during a sampling from a probability distribution of a discrete variable is performed.

10. The information processing device according to claim 9,
wherein the sampling is performed by controlling γ using a following equation:
$$p ( w ; γ ) = p ( w ) \times {e}^{γ {\sum }_{i = 1}^{N} ( 1 - {( 2 σ ( {w}_{i} ) - 1 )}^{2} )}$$
when the probability distribution expanded to the continuous variable is p(w), the strength of the bias is γ, and σ is a sigmoid operation,

11. The information processing device according to claim 10,
wherein the γ is defined from small to large in a following equation:
$$Path γ = {\{ {γ}_{i} \vert ∀ i < j , {γ}_{i} < {γ}_{j} \}}_{i = 1}^{M}$$
and i and j are exchanged during the sampling.

12. The information processing device according to claim 9,
wherein a cost function obtained by formulation performed by a large-scale language model is used as the probability distribution of the discrete variables, and
wherein the process comprises providing the cost function obtained by the sampling to an external solver.
